(19) United States
(12) Patent Application Publication
(10) Pub. No.: US 2009/0006170 A1
(43) Pub. Date: Jan. 1, 2009

(54) PRODUCTION CENTER SYSTEM

(75) Inventor: Robert W. Smith, Gastonia, NC (US)

Correspondence Address: AMIN, TUROCY & CALVIN, LLP, 127 Public Square, 57th Floor, Key Tower, CLEVELAND, OH, 44114, US

(73) Assignee: WACHOVIA CORPORATION, Charlotte, NC (US)

(21) Appl. No.: 11/768,513

(22) Filed: Jun. 26, 2007

(51) Int. Cl. G06Q 10/00

(52) U.S. Cl. 705/9

(57) ABSTRACT

Systems and methods of centralized product production, comprising a job initiation component that receives a job request from a user; a resource management component that delegates tasks to one or more modules to produce a product to meet the job request. The modules can comprise an automated computing system or a practice group, and can report back to the resource management component. An assembly component can receive information, documents, and objects from the resource management component and assemble the items to form a product. An interface component allows a user to view progress of the product, and to receive status updates.

### BACKGROUND

In today's economy, many business deals are complex, multi-faceted transactions involving multiple parties and large sums of money and property. Even in a relatively straight-forward business deal where one company acquires a piece of property or another business, the amount of information relevant to the transaction can be staggering. Teams of financial specialists, management, and other employees can spend hours collecting and compiling data in order to present an idea or a sales pitch. While the amount of data available has increased dramatically with the advent of the internet and other electronic forms of data compilation, storage, and transmission, the amount of time that an executive or board member is available to listen to a sales pitch has trended inversely, giving a presenter even less time to present ideas and propositions than previously available.

Business deals can arise quickly, and without warning. A company may have extremely limited amounts of time to put together a quality sales pitch that includes sufficient information and is organized and informed. A successful presenter should appear fully informed on as many aspects of the deal as possible and have documents ready, whether in electronic format or hard copy, to support assertions and answers. The window of opportunity to successfully close a deal can be brief indeed.

Simply having the information may not be enough to land a client or close a deal. The information should be presented in an organized and uniform manner. Employing enough man power to assemble such information can be an organizational challenge, and the end result can appear out of sync, or disorganized. Additionally, monitoring and managing several teams of experts who may be located throughout the world can be a daunting task.

Workflow systems represent the application of technology to process management that can organize and simplify production of presentation documents and materials. A workflow is an organized set of interrelated tasks that define the operational aspect of a process or procedure. In particular, a workflow defines how tasks are structured, which entities are responsible and relative ordering of tasks, among other things. A workflow facilitates automated design, control and monitoring of processes.

One widely known workflow is the enterprise workflow. A workflow in this domain automates business processes such that documents, information or tasks are passed to individuals for action in accordance with procedural rules. For instance, a worker performs some designated work in a sequence. Subsequently, work by others can be initiated after the worker completes their task. In effect, delivery of work is automated and controlled based on completion of precedent tasks. By way of example, a loan evaluation or approval process could be represented as a workflow.

Workflow can also be associated with computer systems and functionality associate therewith, rather than solely human tasks. For example, workflows can be defined to facilitate data transformation services including processing, cleansing and storing data in a data warehouse, amongst other things.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Systems are provided that can receive a customer request for a product, create and deliver the product, and allow the customer to monitor and view the status of the product as it progresses from incipience to completion. An interface component can receive a job request from the customer including specifics of the desired product, portray the status of the product as it is matures, and facilitate delivery of the finished product. In accordance with an aspect, the product comprises documents relating to a business presentation, including one or more of electronic and tangible documents. In another aspect, a job initiation component can receive a job request from the customer, describing the product the customer seeks. A resource management component can initiate and supervise portions of the production process and delegate tasks to one or more modules. Various entities such as companies, organizations, or automated computing systems, can comprise modules as desired for a certain job. Business units, human resource departments, libraries, or other practice groups are a few example of modules that can be employed by the resource management component.

An assembly component can receive from the resource management component results from one or more module, and assemble the results into a product according to the specifications of the customer. The assembly component can facilitate assembly and production of both electronic information as well as tangible documents and other physical materials. A delivery component can deliver a finished product to the customer in either electronic format or in tangible format (e.g., printed documents, bound books, etc.). The progress of the systems can be viewed by the customer by way of the interface component, allowing the customer to track progress throughout the production process. The customer can request reports of the status, or the system can notify the customer of progress milestones without receiving a specific request.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is an illustrative block diagram of a production center system 100, including a job initiation component 106, a resource management component 108, an assembly component 116, a delivery component 118, and an interface component 126 that allows a customer to track progress of a product.

FIG. 2 is a particular block diagram of a system 200 including an interface component 126 that can provide status updates to a customer, and adapt communications to the customer in accordance with an aspect of the innovation.

FIG. 3 is an illustrative block diagram of an assembly component 116, including a tangible item production component 302 and an electronic item production component 306 that can facilitate delivery of a product to a customer in accordance with an aspect of the innovation.

FIG. 4 is an illustrative interface 400 implemented in connection with the subject system, depicting a job request form in accordance with an aspect of the innovation.

FIG. 5 is an illustrative interface 500 implemented by the subject system, depicting open jobs and in process jobs in accordance with an aspect of the innovation.

FIG. 6 is a particular interface 600 employed by the subject system including search criteria 604 and search results 608 in accordance with an aspect of the innovation.

FIG. 7 is an illustrative flow chart diagram of a methodology 700 of initiating a job request and providing status information to a customer in accordance with an aspect of the innovation.

FIG. 8 is an illustrative flow chart diagram of a methodology 800 of receiving updated information from one or more modules and providing updated information to a customer in accordance with an aspect of the innovation.

FIG. 9 is a schematic block diagram illustrating a suitable operating environment in accordance with an aspect of the innovation.

FIG. 10 is a schematic block diagram of a sample-computing environment in accordance with an aspect of the innovation.

### DETAILED DESCRIPTION

The various aspects of the subject innovation are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

As used in this application, the terms “component” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

Artificial intelligence based systems (e.g., explicitly and/or implicitly trained classifiers) can be employed in connection with performing inference and/or probabilistic determinations and/or statistical-based determinations as in accordance with one or more aspects of the subject innovation as described hereinafter. As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject innovation.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

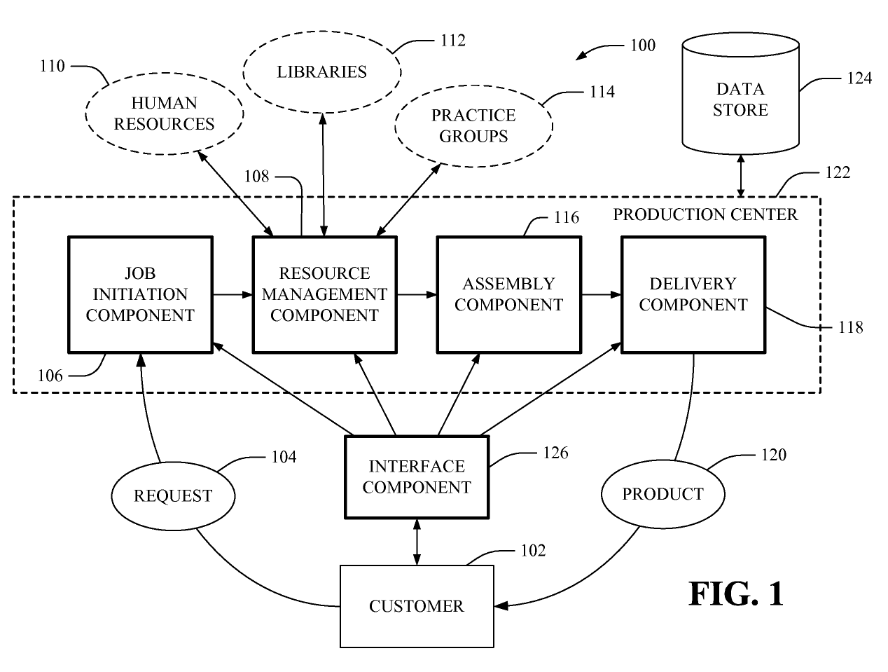

FIG. 1 depicts an illustrative system 100 that allows a customer to send a job request, monitor job progress, and receive a finished product. According to an aspect of the subject innovation, customer 102 can be an individual, an organization, a human operator, or a machine acting under the direction of a human operator (e.g., a human can initiate a request, but the request can be performed and received by a computer or other suitable device). Typically the customer can be interested in financial and other business data, but it is to be appreciated that the subject innovation can apply to virtually all endeavors, including sports, politics, entertainment, and other industries. For purposes of conciseness, the subject innovation is described herein in the context of a business deal. A host (not shown) can be the entity, company, individual, or organization that operates the system 100 and provides the services described. The customer 102 can initiate a job by submitting a job request 104, which can include a description of the job, the results desired, deadline information, and the like. The job request 104 can also include payment information, such offering or requesting a price or payment for the services offered by the system 100. As an example, a job request 104 can include the name and location of a piece of land that a company wishes to purchase, an indication that a title search should be performed, as well as the name and background of the current owner, and so forth. The customer 102 can submit documents in hard copy, or in electronic form along with the job request 104.

The job request 104 can be received by a job initiation component 106, which can process the job request 104 and associated information and documents, and initiate the job. If the customer includes physical documents with the job request 104, the job initiation component 106 can alert an appropriate handler (e.g., a mail room) that the documents are to be expected, and perform appropriate follow-up to ensure that the information submitted is duly received. For example, the job initiation component 106 can send an email to an administrative assistant to expect an envelope from the customer 102 on a given date, and request email confirmation of the envelope. With respect to electronic documents submitted with the job request 104, request can include information that can be directly processed by the job initiation component 106, such as an online submission performed through a web browser, an email, even a telephone call with voice recognition capabilities, or any other appropriate electronic delivery means. The customer 102 can submit electronic files to the job initiation component 106, such as Portable Document Format (PDF) files, word processor documents, spreadsheets, to name a few examples. The job initiation component 106 can serve as an intermediary between the customer 102 and the host for purposes of job commencement, informing the host of the information submitted in the job request 104, and allowing the host to request further information from the customer 102, if so desired.

The job initiation component 106 can communicate with a resource management component 108 to commence work on the job. Resource management component 108 can receive some or all of the information provided by the customer 102 in the job request 104, which can be manipulated or packaged by the job initiation component 106 into a format which allows the resource management component 108 to begin work in a desirable manner. The resource management component 108 can communicate with several modules and delegate tasks to the modules. One example of a module is human resources 110 which can be a human resource department of the host, and can operate to coordinate employee efforts, payment, benefits, and the like. Human resources 110, for example, can identify which employee or employees are available to work on the job, which employees have experience with similar or related jobs or have worked with a specific customer 102 in the past. In the above example of a customer 102 who wishes to purchase a piece of land, human resources 110 can locate individuals with experience with real estate transactions, title searching, property value assessment, and so forth. Another module is generally labeled libraries 112, and can comprise a physical library such as a law library or the library of congress, or an electronic library (e.g., a database, the internet, etc.). Resource management component 108 can perform a search through a library, or request that a search be performed by an employee. Information describing the task at hand as requested by the customer 102 can be supplied to the library 112 to assist with the search. A further example of a module that can be employed by the resource management component 108 is various practice groups 114. In an aspect, different practice groups 114 can have different expertise or experience with a specific job request 104, and therefore can be better suited to handle a given job. For example, if the customer 102 is concerned with potential legal ramifications associated with a deal, a portion of the job request 104 that relates to the legal issues can be delegated to a law firm or in-house counsel; if real estate is at issue, perhaps a real-estate agency is better suited to receive delegations from the resource management component 108 regarding the particulars of a given real-estate transaction.

The foregoing example modules are merely illustrative of operation of the system 100 and the resource management component 108. It is to be appreciated that the modules can comprise any group, entity, computing mechanism, or process that can be at the disposal of the system 100 to work toward the tasks requested by the customer 102 in the job request 104. The resource management component 108 can delegate all or part of a job request 104, up to and including the entire job, as desired. Differing levels of authority and information can be given to different modules for different tasks at different times according to the needs of the customer 102.

Resource management component 108 can compile the results from the modules and deliver the information to the assembly component 116 for further production and assembly. In the example of a job request 104 regarding a real estate transaction, resource management component 108 can deliver electronic files relating to the proposed transaction, as gathered from one or more modules. A title searching module can perform a title search and deliver a PDF file containing the results of the search, and a realtor's office module can deliver a description of the area and surrounding properties. The assembly component 116 can receive these elements and assemble them together into a cohesive whole. According to another aspect, the elements delivered by the modules can be in a more raw format, and the assembly component 116 can reorganize the elements as needed (e.g., alter the format, the layout, the document type, the organization, etc.). An example is to receive several PDF files and one word processed document, and for purposes of uniform delivery, the word processed document can be converted to PDF format. Additionally, the several files can be combined into one file to achieve a more organized presentation. It is to be appreciated that the given examples are not to be viewed as limiting the subject innovation. The assembly component 116 can perform required or desired alterations to the elements provided by a module or group of modules. Moreover, the resource management component 108 can deliver a subset of the results from the modules for assembly, as deemed appropriate. The assembly component 116 can also prepare and deliver a summary of job progress to the customer, details of which are given below.

Once the assembly component 116 receives and assembles sufficient information for delivery, the information can be passed to a delivery component 118 which can deliver a finished product 120 to the customer 102. The delivery component 118 can monitor delivery of tangible products such as paper documents, binders, and the like by electronic means. For example, emails, telephone calls and messages, instant messages, text messages (e.g., Short Message Service (SMS) text messaging) can be initiated by the delivery component to appropriate individuals or units such as a mailing room or to a commercial delivery company such as UPS or FedEx to ensure the deliveries are made appropriately. Regarding electronic delivery, the delivery component can send electronic files through email or other appropriate electronic means. The product 120 can comprise a combination of tangible documents and electronic files, and a customer 102 can elect to receive all or part of the product 120 in both electronic and tangible formats.

According to an aspect, the job initiation component 106, the resource management component 108, and assembly component 116, and the delivery component 118 comprise the production center 122. It is to be appreciated that the functioning of any of these components can be eliminated in whole or in part, or performed by at least one of the other components in the production center 122. Alternatively, the function of one component can be fragmented and performed by two or more components. The production center 122 or any of the components can communicate with a data store 124 to record, store, and read information relating to a given job. There can be a plurality of jobs moving through the production center 122 at any given time, and the several jobs, as well as the status of the job and resources that make up part of a finished product 120, can be stored in the data store 124 for convenient access. The data store 124 can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The data store of the present systems and methods is intended to comprise, without being limited to, these and any other suitable types of memory.

According to an aspect of the subject innovation, the customer can initiate a job request 104 and receive a finished product 120, and can also view the progress of the job at any time during the production through an interface component 126. As shown in FIG. 1, the interface component 126 can communicate with components in the production center 122, and portray information to the customer 102 as often and in as much detail as the customer 102 desires.

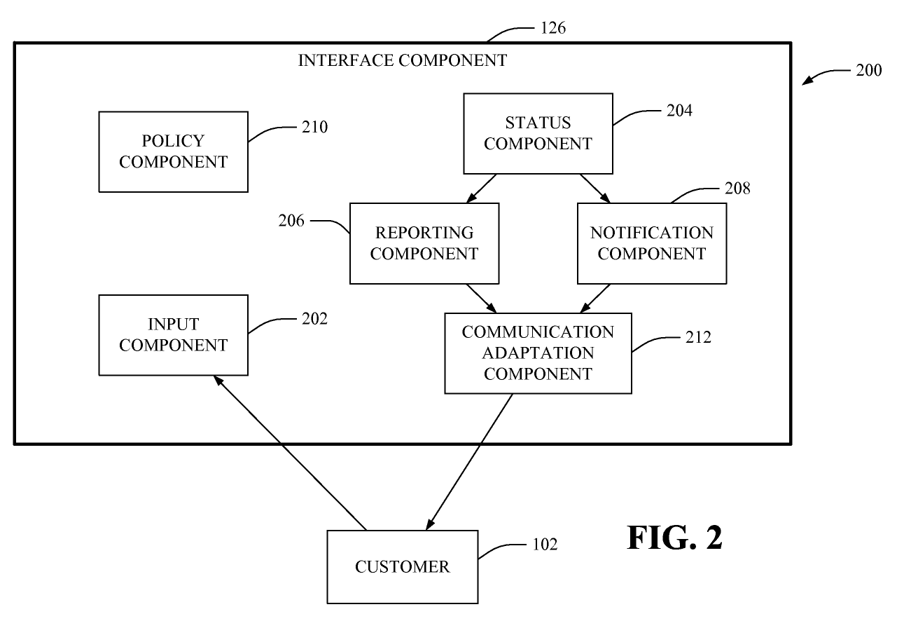

FIG. 2 depicts a system 200 illustrating further operation of the interface component 126. The customer 102 can request information or provide information to the system 200 through the input component 202. In one aspect, the job request 104 (FIG. 1) can be made through the input component 202 of the interface component 126. The interface can be web-based allowing the customer 102 to visit a web-site and provide login information such as a user name and password, and submit information to the production center 122 (FIG. 1) by way of the interface component 126 and make an initial job request 104 by logging into a web-site and transferring documents and files relating to the job request.

After the job is initiated, the customer 102 can submit additional information relating to the job that the customer desires to be included with the final product. For example, a company looking to purchase a piece of property can initiate a job for a pitch-book containing detailed information describing the property, its owners and history, and the like for use at a sales meeting with a board or other governing body of the company. After initiating the job, the company may take additional photographs of the property perhaps to reflect a more current state of the property and submit the photographs to the input component 202 which can convey the submitted information to an appropriate component to include the information with the product. The customer 102 can also submit a request for a status update regarding the progress of the product. The status component 204 can receive the request and query other components as to the status of the job. Job initiation component 106 can provide information regarding the incipience of the job, payment information, due dates and the like. Resource management component 108 (FIG. 1) can provide information relating to the modules to which tasks have been delegated, including the status of the tasks as reported by the modules. Also, future plans can be provided to the status component 204, such as a module that has not been contacted yet, but is planned to receive a delegated task. As an example, the resource management component 108 can identify a law firm to contact once another module returns with case law research results.

Assembly component 116 (FIG. 1) can provide status component 204 with an assembled view of the product as it stands. In another aspect, the assembly component 204 can provide a summary of the product which can contain a brief overview of the product in its current state, and can include planned elements which have yet to be performed. The summary can be one document or a group of documents. In one aspect the summary comprises a multi-level document where a top level includes categories which can contain connections (e.g., hyperlinks, embedded documents) to lower levels with more complete information regarding the category. This can present a clean, simplified summary while simultaneously providing the customer 102 with details and supporting information as needed. Delivery component 118 (FIG. 1) can provide a schedule for delivery (actual or planned) to the status component 204, regarding the delivery of tangible and/or electronic items. Status component 204 can interact with any component of the production center 122 to retrieve information relating to a job as requested by a customer 102.

In order to report information back to the customer 102, interface component 126 can employ a reporting component 206 that can facilitate display of the summary (supplied by the status component 204) to the customer 102. The reporting component 206 can record reports made for future access, and to distribute the report to other individuals. For example, if one member of a team requests a status report, the same report can be sent to other team members according to a predetermined pattern. Moreover, if there has been no progress made or recorded since the last update, the reporting component 206 can simply provide the most recent report to the customer, perhaps with an indication that the report is the same report as issued previously because no progress has been made between requests. Notification component 208 can provide reports to the customer 102 in an aspect, but the operation of this component differs from the reporting component 206 in that the notification component 208 can initiate communications without a customer request. A plurality of methodologies can be employed to generate a notification; for example, if progress on a job reaches a landmark percentage of completion (e.g., 70% complete, 90% complete, 100% complete and ready for delivery), or if delivery is forecast within a set time period (e.g., product delivered in 1 week, 2 days, by end of business, etc.) a notification can issue. Furthermore, the customer 102 can indicate a desire to be notified when certain portions of the product are complete (e.g., when a financial module completes a valuation report).

In addition to receiving explicit user input regarding reporting, artificial intelligence (AI) techniques can be employed by the policy component 210 in accordance with the subject disclosure. For example, in connection with reporting progress, the importance of a given task can be analyzed using various AI schemes. A process for learning explicitly or implicitly whether to report the progress of a job can be facilitated via an automatic classification system and process. Classification can employ a probabilistic and/or statistical-based analysis (e.g., factoring into the analysis utilities and costs) to prognose or infer an action that a user desires to be automatically performed. For example, a support vector machine (SVM) classifier can be employed. Other classification approaches include Bayesian networks, decision trees, and probabilistic classification models providing different patterns of independence can be employed. Classification as used herein also is inclusive of statistical regression that is utilized to develop models of priority.

As will be readily appreciated from the subject specification, the subject invention can employ classifiers that are explicitly trained (e.g., via a generic training data) as well as implicitly trained (e.g., via observing user behavior, receiving extrinsic information) so that the classifier is used to automatically determine according to a predetermined criteria which answer to return to a question. For example, with respect to SVM's that are well understood, SVM's are configured via a learning or training phase within a classifier constructor and feature selection module. A classifier is a function that maps an input attribute vector, x=(x1, x2, x3, x4, xn), to a confidence that the input belongs to a class—that is, f(x)=confidence(class). As shown in FIG. 2, policy component 210 can be employed to facilitate inferring and/or determining when, where, how to initiate a notification or report from the interface component 126 to the customer 102. Characteristics of the customer 102 such as the organization, company, or entity associated with the customer 102, levels of risk tolerance, transaction history, can be entered explicitly by the customer 102 or by the host, or learned implicitly by the policy component 212. This information can be augmented with other contextual information regarding the industry or area a involved with a given job, and used to deliver notifications at appropriate times depending on the customer characteristics. The policy component 210 can employ any of a variety of suitable AI-based schemes as described supra in connection with facilitating various aspects of the subject invention.

According to an aspect of the subject innovation, communication adaptation component 212 can act as a filter for communications and portrayals of information to the customer 102. Characteristics of the customer 102 such as the language spoken, the time zone in which the customer is located, and other information to deliver the report or notification in an appropriate manner. The report or notification can be translated to a language spoken by a given customer 102 and delivered according to a schedule that is convenient for the customer 102 based at least upon time zone information. Moreover, communication adaptation component 212 can interact with policy component 210 to submit notifications in a more proper format, depending on characteristics of a device on which the customer receives the notification. The policy component 210 can maintain a policy that after 5:00 P.M. the customer will most likely be away from the office computer, but will have a mobile device during the commute, or after arriving home. The communication can be adapted accordingly, sending a notification that is more suited to the mobile device (e.g., smaller text, more condensed summary, etc.).

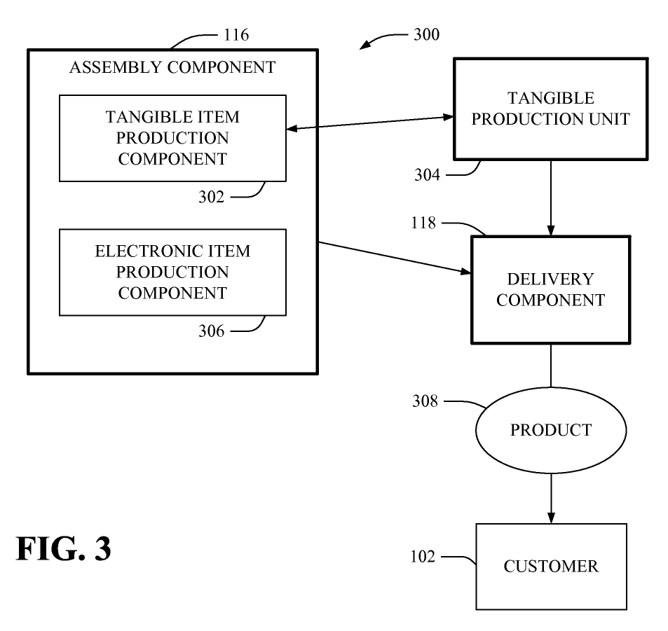

FIG. 3 illustrates a system 300 that facilitates assembly and delivery of a product, describing further operation of the assembly component 116 and delivery component 118. Elements can be passed from the resource management component 108 (FIG. 1) which can include results from a plurality of modules, as described above. The assembly component 116 can include a tangible item production component 302 which can communicate with tangible production unit 304 which can comprise a printing facility or other tools that can produce physical objects for use in a final product (e.g., photography development equipment, a commercial printing operation, etc.). The assembly component 116 can also include an electronic item production component 306 that can administer electronic items such as word processed documents, PDF files, and the like. Both the electronic item production component 306 and the tangible item production component 302 (by way of a tangible production unit 304) can provide the delivery component 118 with materials to deliver to the customer 102 as a final product 308.

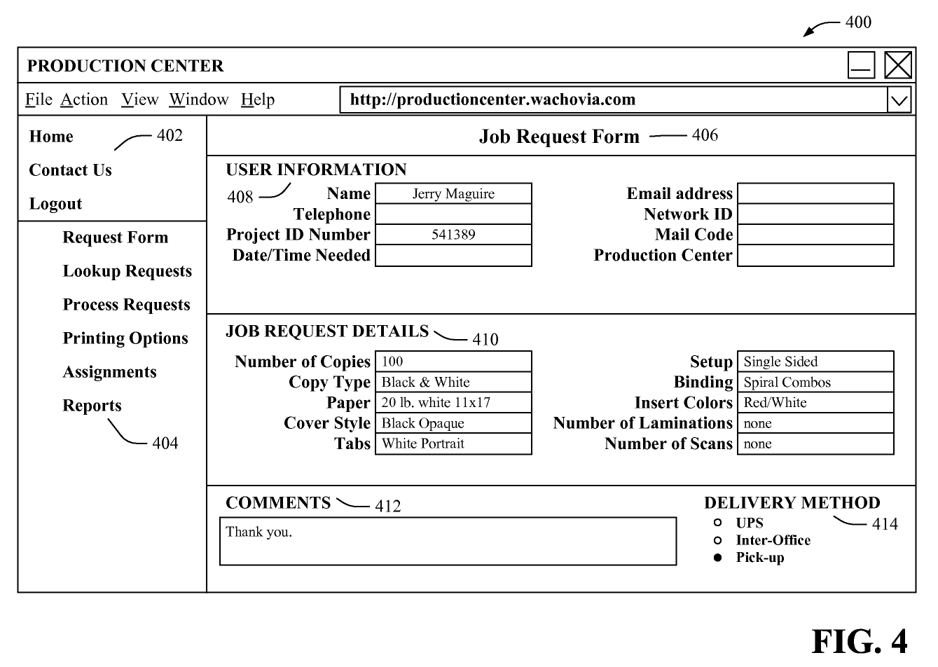

FIG. 4 portrays a production center interface 400 that can be employed by the interface component 126 (FIG. 1) to receive and initiate a job request. In an aspect, the interface 400 can be portrayed through most known internet browsers. A customer can log in by providing a user name and password, or other suitable means of authentication (e.g., challenge/response, biometrics, etc.). A first navigation pane 402 can include links to other areas of a web-site as is known in the art. A second navigation pane 404 located below the first navigation pane 402 can permit a customer to navigate amongst pages and utilities specific to the production center web site. The main window labeled “Job Request Form” 406 can receive input from a customer such as name, telephone number, and email address, for the customer to be identified and to indicate preferred means of communication regarding the job, as shown in a portion of the window labeled “User Information” 408. An email address can be used to send a confirmation email once the job request is received by the production center. It is to be appreciated that the specific information depicted in this figure is merely for purposes of illustration, and is not meant to limit the subject innovation in any way. Other pieces of information may be more or less relevant, and therefore can be included or excluded depending on the particulars of a given implementation.

Below “User Information” 408, a customer can enter “Job Request Details” 410. Such details can include those listed in FIG. 4, relating to number of copies, copy type, color options, and so forth. Again, these examples are illustrative of an illustrative operation according to one aspect of the subject innovation—a given implementation can feature various pieces of information describing a job. A job in which the customer requests only electronic files can omit information such as number of copies, as the customer can print copies if needed, or simply present the files in electronic form. Also depicted is a text box for comments 412 and a set of radio buttons to indicate delivery method 414. These are but a few examples of how the interface 400 can be adapted according to an aspect without departing from the scope of the subject innovation. When the customer has entered the information to his satisfaction, the submit button 416 can be activated, submitting the job request to the appropriate handler. A confirmation email or other notification can be delivered to the customer which can include all or part of the information entered in the job request form window 406. The customer can also submit files as part of the job request form to assist with production. For example, a customer may submit photographs of a piece of property or a building that is the subject of the job request. Additionally, the customer can submit a file that contains some or all of the information required by the job request form 406.

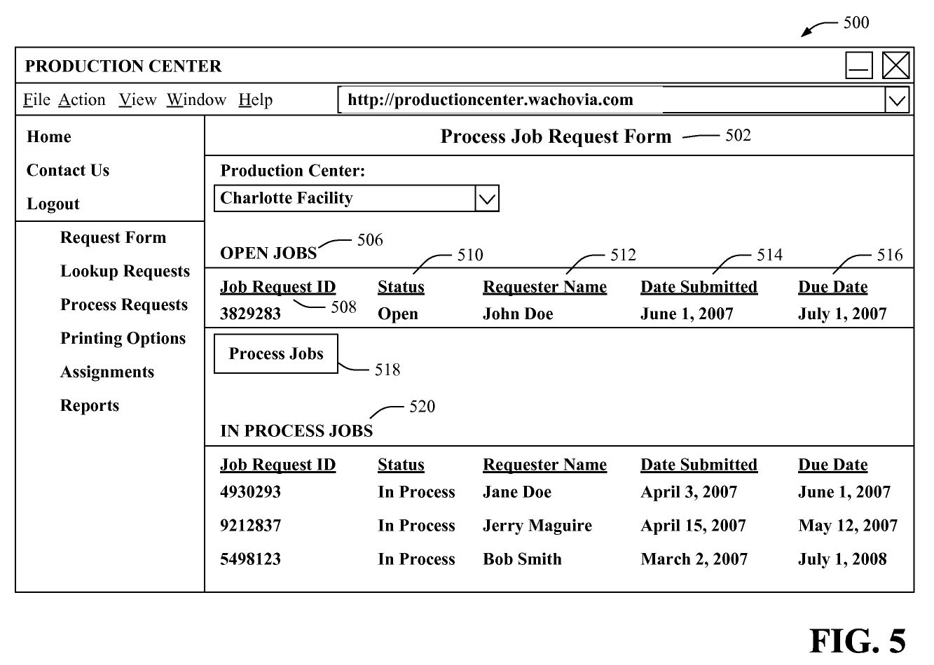

FIG. 5 depicts an interface 500 that can be employed by the interface component 126 (FIG. 1) to allow a customer to browse existing jobs being processed by the production center. The main navigation pane 502 can include an option to select a given production center, which can comprise a physical location where services provided are headquartered. In this example, the customer has selected the Charlotte facility. Another portion of the main navigation page 502 is labeled “Open Jobs” 506, which can refer to the jobs that the customer has opened for viewing. In this illustrative description, there is only one open job listed, and information regarding the open job can be displayed to the customer. In this example, only a few descriptive categories are depicted. The column, “Job Request ID” 508 can refer to a label applied to a job for ease of identification. The column “Status” 510 can denote the progress of the identified job. Item “Requester Name” 512 can indicate the initiator of the job request, whether an individual or a company. Features “Date Submitted” 514 and “Due Date” 516 can describe the dates the job request was received and is due, respectively. This information is merely for descriptive purposes, and it is to be appreciated that the subject innovation is not limited to the type or number of items and descriptions listed. Open Jobs 506 can describe any aspect of an open job to a customer. Button 518 allows the customer to instruct that the open job(s) be processed. This button 518 can have different operations, such as notify a colleague, submit information, and so forth depending on circumstances.

The lower portion labeled “In Process Jobs” 520 can display jobs that have been requested previously and information relating to the process. A customer can quickly browse this list and identify which jobs are pending, when the jobs are due for delivery, and the like. This portion 520 can alternatively display finished jobs, outsourced jobs, and any other description of job the customer is permitted to view, and can list the same or similar information as is listed under “Open Jobs” 506. Also, there can be a plurality of segments such as lower portion 510, and the browser window can scroll down to view them as is well known in the art.

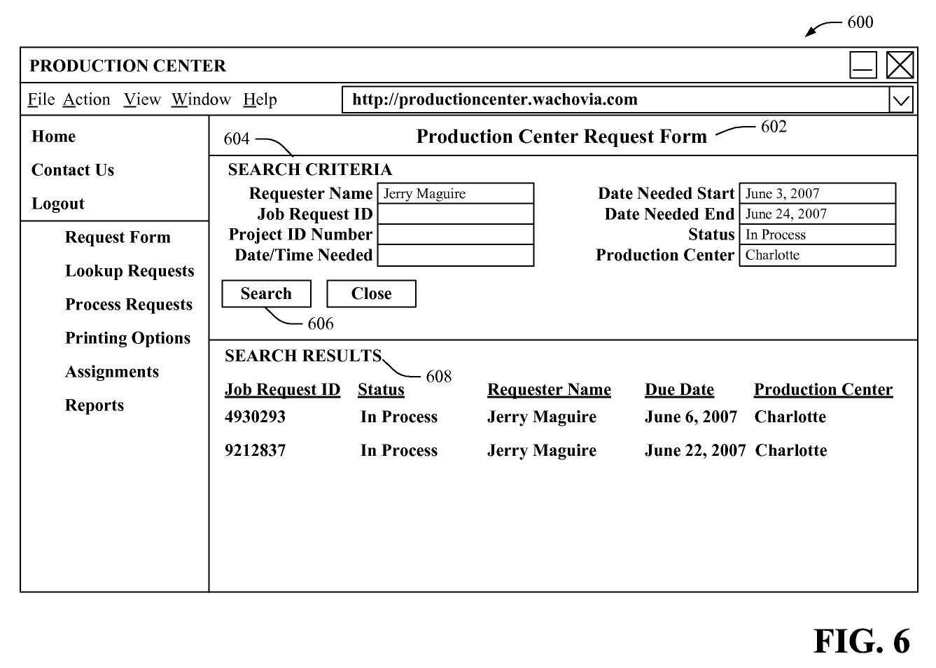

FIG. 6 sets forth a production center interface 600 in which a customer can search for jobs and view the status of a job. The main navigation pane 602 includes a portion labeled “Search Criteria” 604 in which a requesting customer can enter information such as Requester Name and due date and the interface facilitates a search among jobs including the entered information. The values entered in the fields are for purposes of illustration, and indicate that a customer can enter information into as many of the fields as desired, depending on the needs of the customer and the information known to the customer. The customer can invoke the search button 606 to perform the search. Results can be displayed below in the portion labeled “Search Results” 608, and a listing of jobs that meet the search criteria can be provided, as shown. The listing of categories can include any of a plurality of information types, such as percent complete, time remaining before the due date or before delivery, which aspects are complete, which are incomplete, and the like. It is to be appreciated that the interfaces described here (400, 500, and 600) are merely illustrative of an interface that allows a customer to login to a system, view the status of a job, perform a search if desired, according to an aspect of the subject innovation. The detailed implementation of an interface according to the subject system can include virtually any appropriate field such as a text box, a combo box, a radio button, or any equivalent tool to convey and receive information as needed.

The aforementioned systems have been described with respect to interaction between several components. It should be appreciated that such systems and components can include those components or sub-components specified therein, some of the specified components or sub-components and/or additional components. For example, a workflow system can include the interface component 126, the job initiation component 106, the resource management component 108, the assembly component 116 and the delivery component 118, or various combinations of one or more of those components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

Furthermore, as will be appreciated, various portions of the disclosed systems and methods may include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

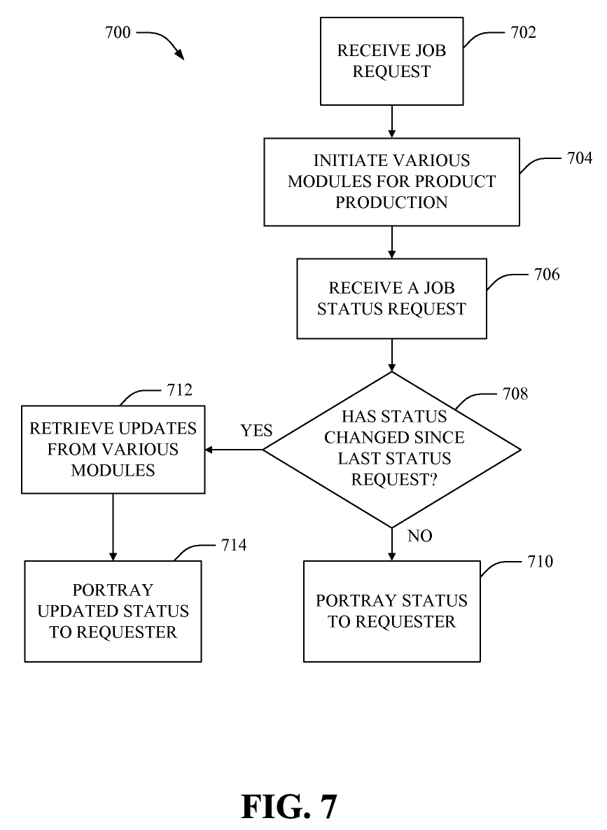

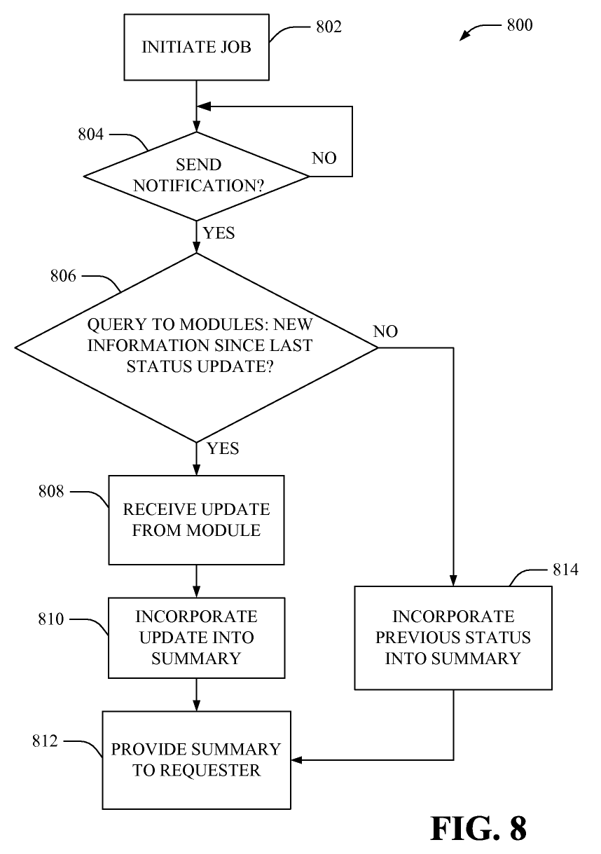

In view of the illustrative systems described supra, methodologies that may be implemented in accordance with the disclosed subject matter will be better appreciated with reference to the flow charts of FIGS. 7 and 8. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 7 depicts a methodology 700 of receiving a job request, and informing a customer who initiated the job request of the progress or status of the request. At reference numeral 702 a job request can be received from a customer. The request can come from a customer logging in to a web browser enabled session over a network such as the internet, employing the interface features described with respect to FIG. 4-6, or from another method of communication such as a telephone call. The request can include an identity of the requester, and details about the requested product. The requester can indicate the content and format of the job, select from several packages or options, or simply describe generally the type of product and the information that should be included and leave the details to the entity that produces the product. At reference numeral 704, one or more modules can be initiated to commence work on the requested product.

Modules can be computing entities (e.g., a server farm, an automated internet based search) or an expert or group of experts in a given field. Modules can include banks, financial planning companies, law firms, research firms, or any other specialty group that can provide services relevant to the requested job. Each module can receive a delegated task, or a portion of the work to be performed to produce the final product. The modules can report back from time to time with their progress, questions, difficulties, and other communications as desired to meet the goals of the customer who requested the product. At reference numeral 706, a request for a status update is received. The customer may wish to track the progress of the product. Circumstances can change, and a product that at one time was required can become irrelevant or unneeded. For a variety of reasons, it can be advantageous to the customer to know where the product stands at a given time in the production process. The request can be received, and at reference numeral 708, the status can be checked against the last update (if any) to determine whether any progress has been made since that time. If not, at reference numeral 710 the previous status condition of the product can be portrayed to the customer. If, on the other hand, one or more modules have made progress since the last update (or since the incipience of the project), the modules can communicate updated information at reference numeral 712, and at reference numeral 714 the updated status can be portrayed to the customer. In this manner, the customer can receive an accurate report of the progress of the requested product. This methodology 700 can repeat if the customer makes additional status requests.

FIG. 8 depicts a methodology 800 to notify a customer of changes made to a requested product. At reference numeral 802, a job can be initiated, in similar fashion to the process described with reference to FIG. 7, including delegation of tasks to various modules. At reference numeral 802, a determination whether to send a notification to the customer can be made. This determination can be based on progress milestones (e.g., completing a percentage of the task, meeting a deadline, etc.), dates (e.g., product to be delivered in two days, etc.), or based on an intelligent determination that a notification is desired. In accordance with an aspect, artificial intelligence techniques can be used to determine whether to notify the customer, and can be based on customer characteristics such as how frequently the customer checks jobs, how important this job is to the customer in relation to other tasks, the amount of time that has passed since the last notification, the customer's reaction to previous notifications, and the like.

Moreover, the determination can be based on occurrences within one or more of the modules. For example, if a bank determines that the customer will not receive credit for a business transaction, this event can be deemed of significant importance that a notification is warranted. If and when a notification is warranted, at reference numeral 806 one or more of the modules can be interrogated for updates or changes in status. The information reported from the modules can be received at reference numeral 808 and incorporated into a summary at reference numeral 810, which can be provided to the customer at reference numeral 812. If no module has information to report, at reference numeral 814 the previous update information can be reported to the customer at reference numeral 812. The summary provided to the customer can be arranged according to module, with a section dedicated to each module that reports updated information. In this way, the summary can provide concise information to the customer, informing the customer of significant changes or progress.

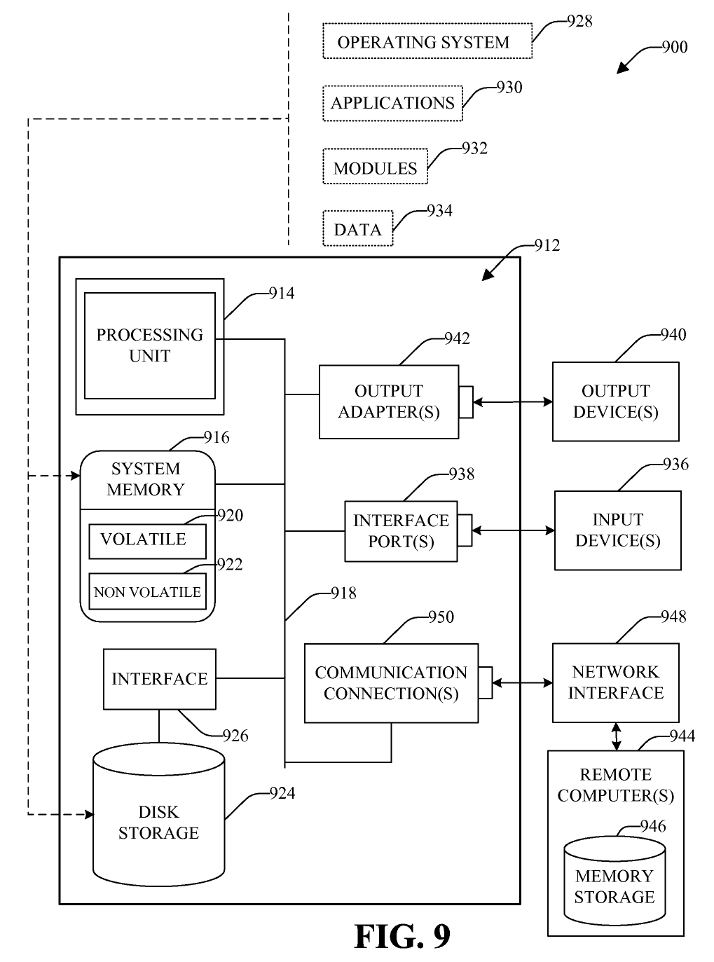

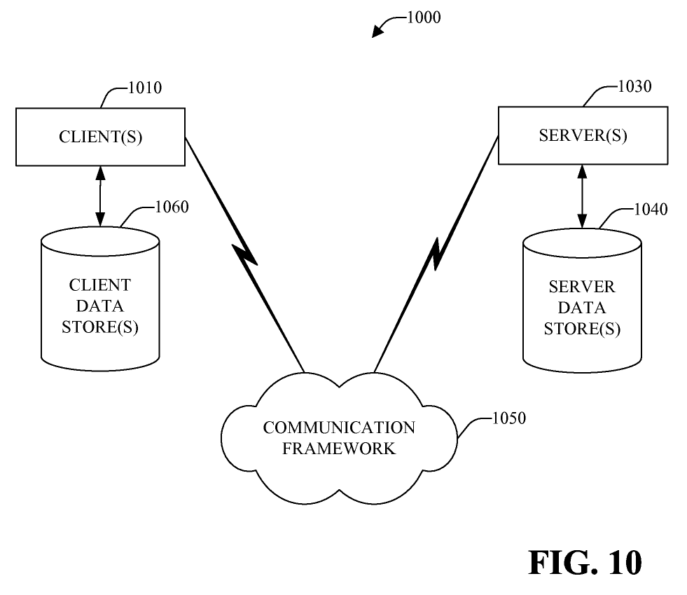

In order to provide a context for the various aspects of the disclosed subject matter, FIGS. 9 and 10 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the invention also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the invention can be practiced on stand-alone computers. In a distributed computing environment, program modules may be located in both local and remote memory storage devices.

With reference to FIG. 9, an illustrative environment 900 for implementing various aspects disclosed herein includes a computer 912 (e.g., desktop, laptop, server, hand held, programmable consumer or industrial electronics . . . ). The computer 912 includes a processing unit 914, a system memory 916, and a system bus 918. The system bus 918 couples system components including, but not limited to, the system memory 916 to the processing unit 914. The processing unit 914 can be any of various available microprocessors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable ROM (EEPROM), or flash memory. Volatile memory 920 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 912 also includes removable/non-removable, volatile/non-volatile computer storage media. FIG. 9 illustrates, for example, disk storage 924. Disk storage 924 includes, but is not limited to, devices like a magnetic disk drive, floppy disk drive, tape drive, Jaz drive, Zip drive, LS-100 drive, flash memory card, or memory stick. In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used such as interface 926.

It is to be appreciated that FIG. 9 describes software that acts as an intermediary between users and the basic computer resources described in suitable operating environment 900. Such software includes an operating system 928. Operating system 928, which can be stored on disk storage 924, acts to control and allocate resources of the computer system 912. System applications 930 take advantage of the management of resources by operating system 928 through program modules 932 and program data 934 stored either in system memory 916 or on disk storage 924. It is to be appreciated that the present invention can be implemented with various operating systems or combinations of operating systems.

A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912 and to output information from computer 912 to an output device 940. Output adapter 942 is provided to illustrate that there are some output devices 940 like displays (e.g., flat panel and CRT), speakers, and printers, among other output devices 940 that require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit-switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for illustrative purposes only, internal and external technologies such as, modems including regular telephone grade modems, cable modems, power modems and DSL modems, ISDN adapters, and Ethernet cards or components.

FIG. 10 is a schematic block diagram of a sample-computing environment 1000 with which the present invention can interact. The system 1000 includes one or more client(s) 1010. The client(s) 1010 can be hardware and/or software (e.g., threads, processes, computing devices). The system 1000 also includes one or more server(s) 1030. Thus, system 1000 can correspond to a two-tier client server model or a multi-tier model (e.g., client, middle tier server, data server), amongst other models. The server(s) 1030 can also be hardware and/or software (e.g., threads, processes, computing devices). The servers 1030 can house threads to perform transformations by employing the present invention, for example. One possible communication between a client 1010 and a server 1030 may be in the form of a data packet adapted to be transmitted between two or more computer processes.

The system 1000 includes a communication framework 1050 that can be employed to facilitate communications between the client(s) 1010 and the server(s) 1030. The client(s) 1010 are operatively connected to one or more client data store(s) 1060 that can be employed to store information local to the client(s) 1010. Similarly, the server(s) 1030 are operatively connected to one or more server data store(s) 1040 that can be employed to store information local to the servers 1030.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” or variations thereof are used in either the detailed description or the claims, such terms are intended to be inclusive in a manner similar to the term “comprising” as “comprising” is interpreted when employed as a transitional word in a claim.

What is claimed is:

1. A system of centralized product production, comprising:
a job initiation component that receives a job request from a user;
a resource management component that delegates tasks to one or more modules to produce a product to meet a subset of the job request, the modules report back to the resource management component;
an assembly component that receives items from the resource management component and assembles the items to form the product; and
an interface component that allows the user to view progress of the product.

2. The system of claim 1, further comprising a delivery component that delivers the product to the user.

3. The system of claim 1, the product comprises at least one of electronic information or tangible documents.

4. The system of claim 1, the interface component utilizes a web browser.

5. The system of claim 1, further comprising a notification component that sends a confirmation to the user to confirm receipt of the job request.

6. The system of claim 1, the one or more modules comprise at least one of an automated computing facility or a practice group.

7. The system of claim 1, the interface component further comprising:
a status component that communicates with the resource management component to receive status updates from at least a subset of the one or more modules; and
a reporting component that receives status information from the status component and provides the user with a progress report.

8. The system of claim 7, the progress report includes status information from the subset of the one or more modules.

9. The system of claim 7, further comprising a communication adaptation component that interacts with a policy component that employs one or more policies to create the progress report.

10. The system of claim 9, the progress report is adapted according to at least one policy that relates to a characteristic of the customer.

11. The system of claim 9, the progress report is adapted according to at least one policy that relates to at least one characteristic of the product.

12. The system of claim 9, the progress report is adapted according to at least one policy that relates to the one or modules.

13. A method of product workflow processing, comprising:
receiving a job request from a user;
delegating at least a portion of the job request to one or more modules;
receiving results from the one or more modules;
assembling the results from the one or more modules into a final product; and
allowing the user to view the progress of the job request during production.

14. The method of claim 13, further comprising delivering the final product to the user.

15. The method of claim 13, the final product comprises at least one of electronic information or tangible objects.

16. The method of claim 13, further comprising sending a report describing the progress of the job request to the user.

17. The method of claim 16, the report is tailored to the user, according to one or more characteristics of at least one of the user, the product, or the one or more modules.

18. The method of claim 16, further comprising sending the report in response to a status inquiry made by the user.

19. The method of claim 16, the report comprises a summary of the progress.

20. A system for centralized management of product production, comprising:
means for receiving a job request from a customer that includes a description of the product desired;
means for allocating responsibility for portions of the product to one or more modules;
means for receiving information from the one or more modules relating to job progress; and
interface means for permitting the user to view job progress.
